(19) United States
(12) Patent Application Publication
(10) Pub. No.: US 2022/0019375 A1
(43) Pub. Date: Jan. 20, 2022

(54) ABNORMAL CONDITION DETECTION BASED ON TEMPERATURE MONITORING OF MEMORY DIES OF A MEMORY SUB-SYSTEM

(71) Applicant: Micron Technology, Inc., Boise, ID (US)

(72) Inventors: Zhenming Zhou, San Jose, CA (US); Jiangli Zhu, San Jose, CA (US)

(21) Appl. No.: 16/928,746

(22) Filed: Jul. 14, 2020

(51) Int. Cl. G06F 3/06; G01K 3/00; G01K 1/02; G01K 3/08

(52) U.S. Cl. CPC G06F 3/0659; G06F 3/0604; G06F 3/0653; G01K 3/08; G01K 3/005; G01K 1/026; G01K 1/022; G06F 3/0673

(57) ABSTRACT

A set of temperature measurements corresponding to a set of memory dies of a memory sub-system is collected. The set of temperature measurements includes a temperature measurement determined for each memory die of the set of memory dies. A determination is made whether a first temperature measurement of the set of temperature measurements satisfies a first condition. It is determined whether a temperature variation of the set of temperature measurements satisfies a second condition. In response to a determination that the first temperature measurement satisfies the first condition or the temperature variation satisfies the second condition, a temperature related event is logged. A message is sent to a host system indicating the temperature related event.

### TECHNICAL FIELD

Embodiments of the disclosure relate generally to memory sub-systems, and more specifically, relate to detecting abnormal conditions based on temperature monitoring of memory dies of a memory sub-system.

### BACKGROUND

A memory sub-system can be a storage system, a memory module, or a hybrid of a storage device and memory module. The memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 illustrates an example computing system that includes a memory sub-system in accordance with some embodiments of the present disclosure.

FIG. 2 is a flow diagram of an example method to identify a temperature related event associated with a set of memory dies of a memory sub-system in accordance with some embodiments.

FIG. 3 illustrates an example system including a temperature monitoring component configured to identify one or more temperature related events associated with in-channel or cross-channel subsets of memory dies in accordance with some embodiments.

FIG. 4 illustrates a table including temperature related threshold levels and temperature measurements associated with a set of memory dies of a memory sub-system in accordance with some embodiments.

FIG. 5 is a block diagram of an example computer system in which implementations of the present disclosure can operate.

### DETAILED DESCRIPTION

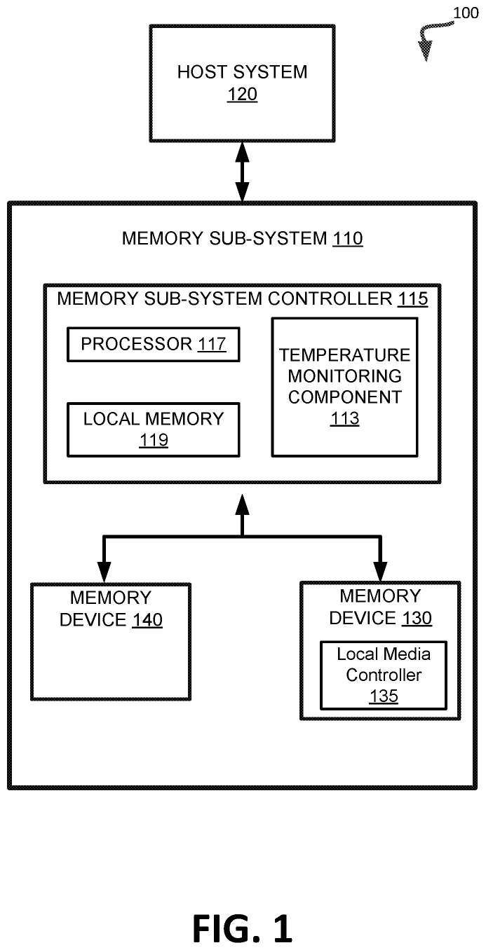

Aspects of the present disclosure are directed to detecting abnormal conditions based on temperature monitoring of memory dies of a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory devices. The host system can provide data to be stored at the memory sub-system and can request data to be retrieved from the memory sub-system.

The memory devices can be non-volatile memory devices, such as three-dimensional cross-point (“3D cross-point”) memory devices that are a cross-point array of non-volatile memory that can perform bit storage based on a change of bulk resistance, in conjunction with a stackable cross-gridded data access array. Another example of a non-volatile memory device is a negative-and (NAND) memory device. Other examples of non-volatile memory devices are described below in conjunction with FIG. 1.

Each of the memory devices can include one or more arrays of memory cells. A memory cell (“cell”) is an electronic circuit that stores information. Depending on the cell type, a cell can store one or more bits of binary information, and has various logic states that correlate to the number of bits being stored. The logic states can be represented by binary values, such as “0” and “1”, or combinations of such values. For example, a single level cell (SLC) can store one bit of information and has two logic states. The various logic states have corresponding threshold voltage levels. A threshold voltage (VT) is the voltage applied to the cell circuitry (e.g., control gate at which a transistor becomes conductive) to set the state of the cell. A cell is set to one of its logic states based on the VT that is applied to the cell. For example, if a high VT is applied to an SLC, a charge will be present in the cell, setting the SLC to store a logic 0. If a low VT is applied to the SLC, charge will be absent in the cell, setting the SLC to store a logic 1.

3D cross-point memory device configurations can include multiple memory dies per memory channel in a multi-channel arrangement. Each memory die can have a temperature sensor configured to detect a temperature of the memory die. The temperature sensor can determine a real-time temperature value for the memory die that is updated in each memory die's register. Conventional 3D cross-point memory devices can read out a temperature value of each memory die (e.g., in the form of a temperature code). The temperature information of each memory die is then used to conduct thermal management actions, such as thermal throttling. Furthermore, conventional systems identify only a highest temperature value for each memory device, failing to capture other temperature-related effects on a performance of the memory device. For example, reliability of the data stored by the memory device can suffer from a risk of transient or alternating current variation power violations.

In addition, conventional systems fail to monitor and detect temperature-related impact on read errors (e.g., UECC). Moreover, in conventional systems, a host system is unaware of temperature code read failures (e.g., the temperature code value for a memory drive is incorrect) that can indicate a risk in the data transfer path to a host system and temperature-related memory die functionality failures (e.g., read operation errors). In this regard, conventional systems fail to use temperature data associated with the memory dies to monitor data reliability risks including read operation errors and data transfer or data path issues.

Aspects of the present disclosure address the above and other deficiencies by having a memory sub-system that determines a temperature-related event associated with a set of memory dies across multiple channels of a memory sub-system and provides a message to a host system to enable remedial action. In an embodiment, a controller of the memory sub-system can perform in-channel or cross-channel memory die temperature monitoring to determine temperature measurements corresponding to a set of memory dies (e.g., a set of cross-channel memory dies of multiple channels or a set of in-channel memory dies of a single channel). The controller can periodically (e.g., every 10 seconds, every 15 seconds, every 20 seconds, etc.) check to determine a temperature measurement value (referred to as a “temperature measurement”) corresponding to the set of memory dies.

The temperature monitoring can be performed on different memory die located in different channels of the memory device having different physical positions within the memory device. The cross-channel temperature monitoring enables the identification of a difference in temperatures (e.g., a temperature variation) among the set of cross-channel memory dies to determine a thermal stability of the memory sub-system.

The controller monitors the cross channel die temperature to enable the host system to identify temperature-related risks due to the memory drive hardware or environmental factors (e.g., power supply levels, thermal air flow levels, etc.).

Advantages of the present disclosure include, but are not limited to, identifying one or more temperature-related events associated with multiple memory dies of multiple channels of a memory device. The controller generates and sends a message to alert the host system of the one or more temperature-related events impacting one or more power management or data error issues. Advantageously, the host system can use the information concerning the one or more temperature-related events to execute a corresponding remedial action, such as performing a failure analysis operation, slow or stop data traffic to and from the host system to manage data integrity issues, examine and evaluate existing environment factors (e.g., power supply levels, thermal air flow levels, etc.)

FIG. 1 illustrates an example computing environment 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, a vehicle (e.g., airplane, drone, train, automobile, or other conveyance), Internet of Things (IoT) devices, embedded computer (e.g., one included in a vehicle, industrial equipment, or a networked commercial device), or such computing device that includes a memory and a processing device. The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Although non-volatile memory components such as 3D cross-point type memory are described, the memory device 130 can be based on any other type of non-volatile memory, such as negative-and (NAND), read-only memory (ROM), phase change memory (PCM), self-selecting memory, other chalcogenide based memories, ferroelectric random access memory (FeRAM), magneto random access memory (MRAM), negative-or (NOR) flash memory, and electrically erasable programmable read-only memory (EEPROM).

One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory component can include an SLC portion, and an MLC portion, a TLC portion, or a QLC portion of memory cells. The memory cells of the memory devices 130 can be grouped as pages or codewords that can refer to a logical unit of the memory device used to store data. With some types of memory (e.g., NAND), pages can be grouped to form blocks. Some types of memory, such as 3D cross-point, can group pages across dice and channels to form management units (MUs).

The memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 may not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a temperature monitoring component 113 that can be used to monitor temperatures associated with a set of memory dies of a memory sub-system. In some embodiments, the temperature monitoring component 113 stores each temperature measurement for the set of memory dies in a data store (e.g., cache storage of the memory sub-system controller 115). The temperature monitoring component 113 can analyze the temperature data associated with the memory dies and identify the occurrence of one or more temperature-related events. In some embodiments, the set of memory dies can include in-channel memory dies (e.g., the memory dies are in the same channel) or cross-channel memory dies (e.g., the memory dies are in multiple different channels of the memory device). In some embodiments, a first temperature-related event is identified if a temperature measurement (e.g., a temperature value) detected for one or more of the memory dies of the set of memory dies satisfies a first condition. The first condition is satisfied if the temperature measurement associated with one or more memory dies is not within an acceptable or threshold temperature range. The temperature monitoring component 113 maintains a threshold temperature range having a minimum temperature value and a maximum temperature value. The temperature monitoring component 113 collects (e.g., periodically) the temperature measurements from one or more temperature detectors associated with the set of memory dies and compares the measured values with the threshold temperature range to determine if one or more of the temperature measurements fall outside the range (e.g., a memory die has a temperature value that is either below the minimum temperature value or above the maximum temperature value.

In some embodiments, the temperature monitoring component 113 identifies an occurrence of a second temperature-related event if a temperature variation among the set of memory dies satisfies a second condition. The second condition is satisfied if the temperature variation associated with the set of memory dies (e.g., an in-channel set of memory dies or a cross-channel set of memory dies) exceeds a threshold variation level. In some embodiments, the temperature monitoring component 113 executes a reading of the temperature measurements associated with a set of memory dies as detected by one more temperature detectors. The temperature monitoring component 113 identifies a lowest temperature measurement and a highest temperature measurement for the set of memory dies. temperature monitoring component 113 determines the temperature variation as represented by a difference between the highest temperature measurement and the lowest temperature measurement. The second condition is satisfied if the temperature variation associated with the set of memory dies is greater than the acceptable or threshold variation level.

In some embodiments, in response to the detection of one or more temperature-related events, the temperature monitoring component 113 generates and send a communication to the host system 120 including information associated with the identified temperature-related event. Advantageously, the reporting of the temperature-related events by the temperature monitoring component 113 enables the host system 120 to identify and respond to abnormal conditions, such as issues in the data path, power stability issues, problematic thermal environment factors which can produce read errors and data unreliability.

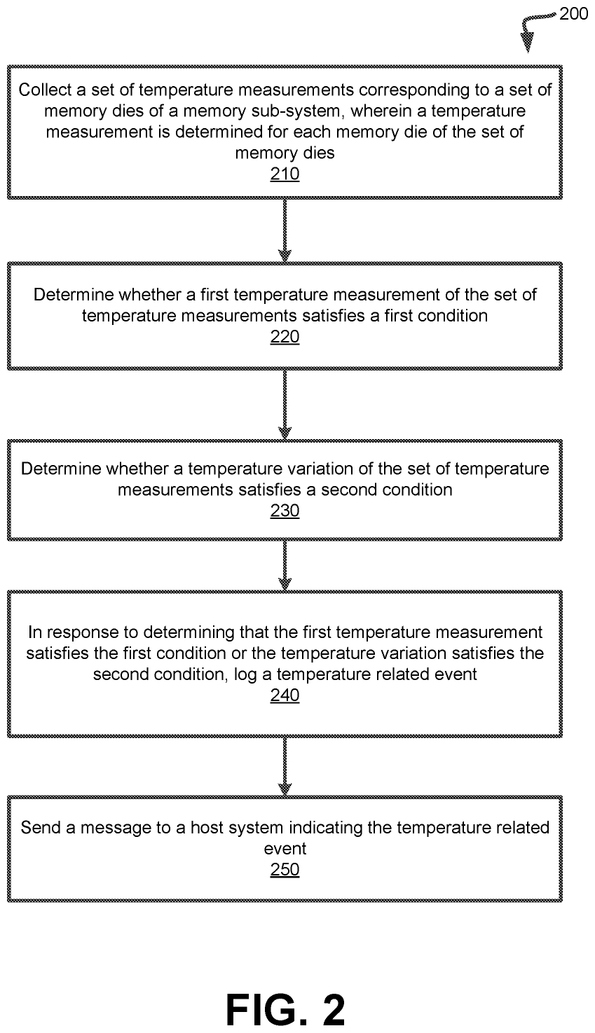

FIG. 2 is a process flow diagram of an example method 200 to identify and report temperature-related events associated with a set of memory dies of a memory sub-system in accordance with some embodiments. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the temperature monitoring component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

As shown in FIG. 2, at operation 210, the processing logic collects a set of temperature measurements corresponding to a set of memory dies of a memory sub-system, wherein a temperature measurement is determined for each memory die of the set of memory dies. In an embodiment, the set of memory dies can include memory dies in a channel of a memory device (e.g., an in-channel set of memory dies). In this embodiment, the set of temperature measurements includes a set of in-channel temperature measurements including a detected or measured temperature value for each of the memory dies in the channel. In an embodiment, the set of memory dies can include memory dies in multiple different channels of a memory device (e.g., a cross-channel set of memory dies). In this embodiment, the set of temperature measurements includes a set of cross-channel temperature measurements including a detected or measured temperature value for each of the memory dies in multiple channels of the memory device.

In an embodiment, the processing logic collects the set of temperature measurements according to a predetermined frequency or period (e.g., every 10 seconds, every 15 seconds, every 20 seconds, etc.). In an embodiment, the temperature measurements can be identified by one or more temperature detectors associated with the set of memory dies and stored as a temperature code in a register of the memory device. The processing logic can conduct a temperature code examination operation with respect to the memory die registers to retrieve or collect the set of temperature measurements.

In operation 220, the processing logic determines whether a first temperature measurement of the set of temperature measurements satisfies a first condition. In an embodiment, the first condition is satisfied if a temperature measurement of the set of temperature measurements is not within an acceptable or threshold temperature range defined by a minimum temperature value and a maximum temperature value. In some embodiments, the processing logic compares each of the temperature measurements to the threshold temperature range to determine if one or more of those measurements (e.g., the first temperature measurement) fall outside of the range.

In operation 230, the processing logic determines whether a temperature variation of the set of temperature measurements satisfies a second condition. In an embodiment, the second condition is satisfied if a temperature variation among the set of temperature measurements is greater than a threshold variation level. In an embodiment, the processing logic reviews the set of temperature measurements and identifies a lowest temperature value (e.g., T_{lowest}) and a highest temperature value (e.g., T_{highest}). In an embodiment, the processing logic can determine a temperature variation by computing a difference between the highest temperature value and the lowest temperature value.

In operation 240, in response to determining that the first temperature measurement satisfies the first condition or the temperature variation satisfies the second condition, the processing device logs a temperature related event. In an embodiment, the first condition is satisfied by a first temperature measurement if the first temperature measurement is either less than a minimum acceptable temperature level or greater than a maximum acceptable temperature level. In an embodiment, the second condition is satisfied if the temperature variation among the temperature measurements of the set of memory dies is greater than a predetermined threshold variation level.

In some embodiments, the one or more temperature related events can be identified in response to either the satisfaction of the first condition, the satisfaction of the second condition, or both. In an embodiment, the processing device logs or stores information relating to the temperature related event including a type of temperature related event (e.g., a first type associated with a first temperature measurement falling outside of the acceptable range or a second type associated with the temperature variation associated with the set of memory dies exceeding a threshold variation level.)

In operation 250, the processing logic sends a message to a host system indicating the temperature related event. In an embodiment, the message may include information identifying the temperature related event (e.g., event type, one or more memory dies that satisfied the first condition, whether the set of memory dies include an in-channel set or a cross-channel set, etc.). In response to receipt of the message, the host system can execute a remedial action to address one or more performance issues that can be produced by or associated with the temperature related event. Exemplary remedial actions can include, but are not limited to, executing a failure analysis operation, stopping or slowing data traffic transmitted to and from the host system (e.g., to avoid or reduce data integrity issues associated with the one or more temperature related events), reviewing environmental conditions such as power supply levels, thermal air flow levels, etc.).

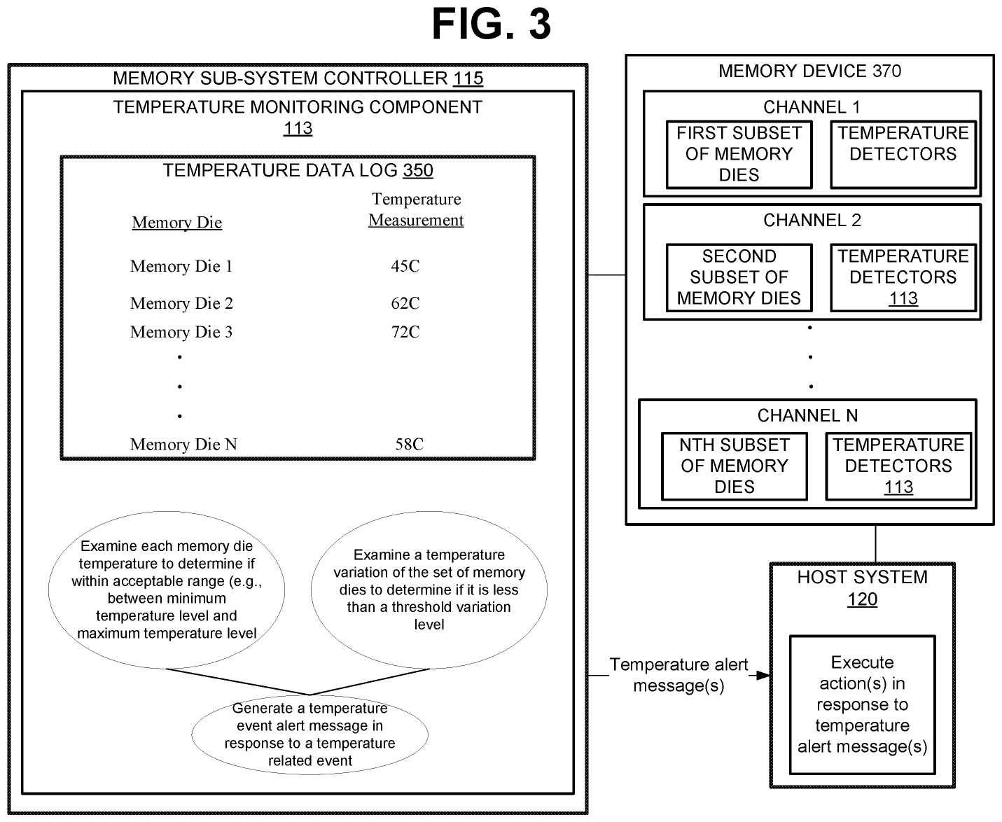

FIG. 3 illustrates an example system including a temperature monitoring component 113 of a memory sub-system controller 115 configured to determine temperature measurements associated with memory dies of a memory device 370. As shown in FIG. 3, the memory device 370 can include multiple channels (e.g., channel 1 through channel N), where each channel includes a subset of memory dies. Each subset of memory dies can be associated with one or more temperature detectors configured to detect a temperature value for each memory die in the subset. In an embodiment, the temperature monitoring component 113 can maintain a data store (e.g., temperature data log 350) including collected temperature measurements corresponding to the memory dies of one or more of the subsets of memory dies. In an embodiment, a cross-channel set of memory dies for all of the channels (e.g., channel 1 through channel N) or a portion including multiple channels (e.g., the first subset and the second subset, the second subset and the Nth subset, the first subset and the Nth subset, etc.) can be collected and analyzed by the temperature monitoring component 113. In an embodiment, an in-channel set of memory dies (e.g., the first subset of memory dies) can be collected and analyzed by the temperature monitoring component 113.

As shown in the example of FIG. 3, the temperature data log 350 includes temperature measurements corresponding to memory die 1 through memory die N. It is noted that the set of memory dies identified in the temperature data log 350 can be the first subset of memory dies, the second subset of memory dies, the nth subset of memory dies, or any combination thereof.

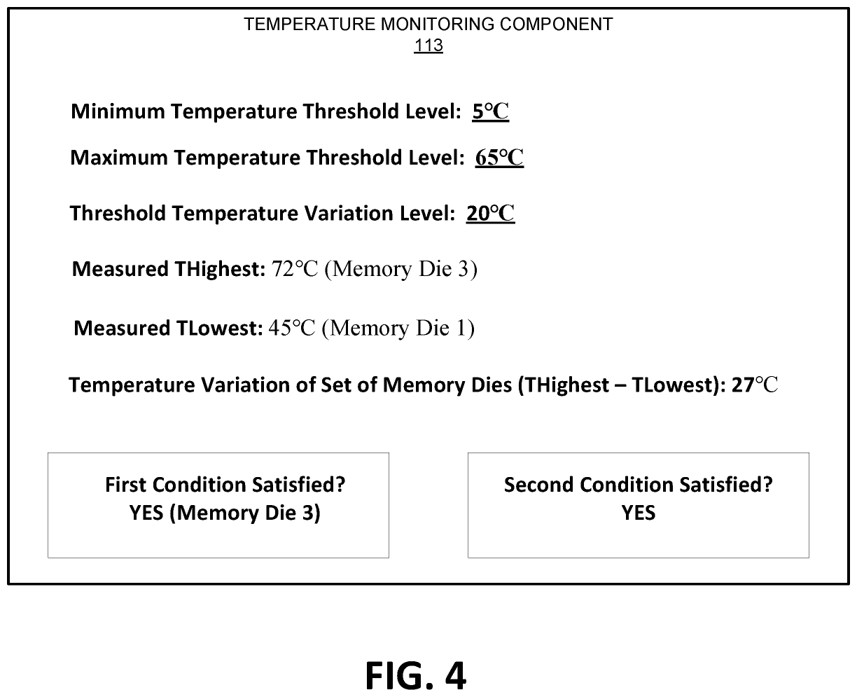

According to embodiments, the temperature monitoring component 113 examines the temperature measurement in the data log 350 to determine if each value is within the acceptable range defined by a minimum temperature level and a maximum temperature level. In the example shown in FIG. 3 and FIG. 4, the minimum temperature threshold level is set to 5° C. and the maximum temperature threshold level is set to 65° C. As shown in FIGS. 3 and 4, the temperature monitoring component 113 examines the set of temperature measurements and identifies a highest measured temperature (e.g., T_{Highest}) and a lowest measured temperature (e.g., T_{Lowest}). In the example shown, Memory Die 3 is identified by the temperature monitoring component 113 as having a T_{Highest} value of 72° C. In the example shown, Memory Die 1 is identified by the temperature monitoring component 113 as having a T_{Lowest} value of 45° C. The temperature monitoring component 113 compares the measured T_{Lowest} value (45° C.) to the minimum temperature threshold level (5° C.) and compares the measured T_{Highest} value (72° C.) to the maximum temperature threshold level (65° C.) to determine if the first condition is satisfied. In this example, it is determined that the first condition is satisfied by the temperature measurement associated with Memory Die 3, resulting in the identification of a temperature related event.

In this example, the temperature monitoring component 113 further examines the temperature data log 350 to determine if a temperature variation is less than or greater than a threshold variation level. In the example shown in FIGS. 3 and 4, the threshold variation level is set to 20° C. In an embodiment, the temperature monitoring component 113 determines the temperature variation for the set of memory dies is 27° C. (e.g., the difference between the highest measured temperature and the lowest measured temperature). The identified temperature variation of 27° C. exceeds the established threshold variation level and, accordingly, satisfies the second condition, resulting in a temperature related event.

In the example shown, the temperature monitoring component 113 generates one or more temperature event alert messages in response to the identified temperature related events. The temperature monitoring component 113 sends the one or more temperature alert messages to the host system 120, which, in response, can execute remedial action or operation. Advantageously, the identifying of temperature related events and reporting to the host system 120 enables the memory sub-system controller 115 to monitor and detect abnormal conditions in the data path, power stability, and thermal environment. The temperature alert message and information about the temperature related event can be used by the host system 120 as a data point during failure analysis when read errors occur. In some embodiments, the temperature alert message can serve as an alarm to the host system 120 to enable the avoidance of read errors in light of the temperature monitoring. Another advantage can be realized by embodiments of the present disclosure wherein cross-channel temperature monitoring is performed to collect temperature measurements across all channels and memory dies of the memory device.

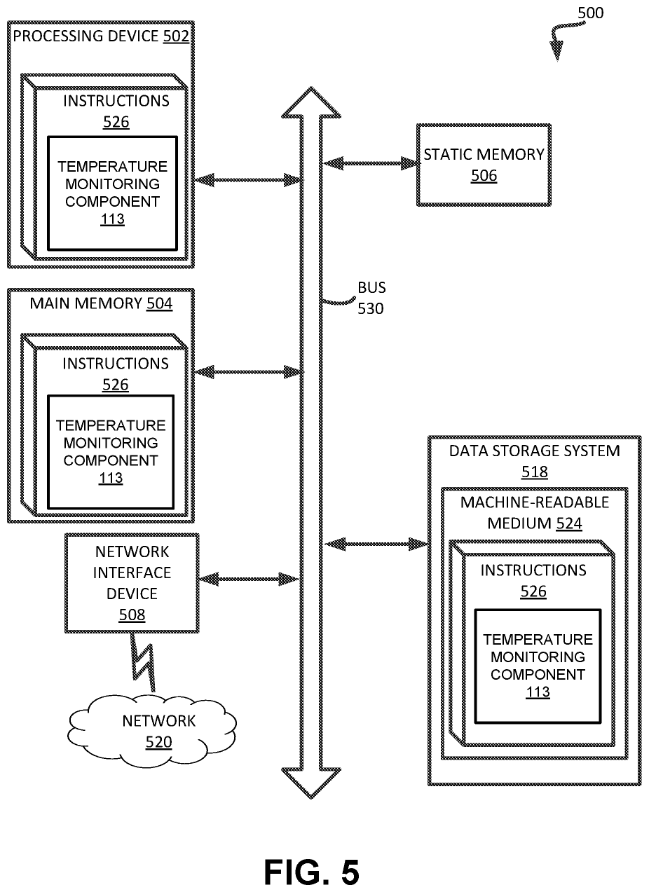

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to a temperature monitoring component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, digital or non-digital circuitry, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a refresh operation component (e.g., the temperature monitoring component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
collecting, by a processing device, a set of temperature measurements corresponding to a set of memory dies of a memory sub-system, wherein a temperature measurement is determined for each memory die of the set of memory dies;
determining whether a first temperature measurement of the set of temperature measurements satisfies a first condition;
determining whether a temperature variation of the set of temperature measurements satisfies a second condition;
in response to determining that the first temperature measurement satisfies the first condition or the temperature variation satisfies the second condition, log a temperature related event; and
sending a message to a host system indicating the temperature related event.

2. The method of claim 1, wherein the host system executes one or more remedial actions in response to the message.

3. The method of claim 1, wherein the first condition is satisfied upon determining that the first temperature measurement is less than a minimum temperature threshold level or upon determining that the first temperature measurement is greater than a maximum temperature threshold level.

4. The method of claim 1, further comprising determining a highest temperature measurement of the set of temperature measurements and a lowest temperature measurement of the set of temperature measurements, wherein the temperature variation is a difference between the highest temperature measurement and the lowest temperature measurement.

5. The method of claim 4, wherein the second condition is satisfied upon determining the temperature variation is greater than a threshold temperature variation level.

6. The method of claim 1, further comprising maintaining a data log comprising the set of temperature measurements.

7. The method of claim 1, wherein the set of memory dies comprises a first subset of memory dies of a first channel and a second subset of memory dies of a second channel.

8. A non-transitory computer readable medium comprising instructions, which when executed by a processing device, cause the processing device to perform operations comprising:
store a set of temperature measurements corresponding to a plurality of subsets of memory dies of a plurality of different channels of a memory sub-system;
identify one or more temperature related events based on the set of temperature measurements;
generate an alert message identifying the one or more temperature related events; and
send the alert message to a host system, wherein the host system executes a remedial action in response to the alert message.

9. The non-transitory computer readable medium of claim 8, wherein the one or more temperature related events comprise a first event type identified in response to a temperature measurement of the set of temperature measurements that is not within a threshold temperature range.

10. The non-transitory computer readable medium of claim 8, wherein the one or more temperature related events comprise a second event type identified in response to a temperature variation of the set of temperature measurements that is greater than a threshold temperature variation level.

11. The non-transitory computer readable medium of claim 10, wherein the temperature variation represents a difference between a highest temperature measurement of the set of temperature measurements and a lowest temperature measurement of the set of temperature measurements.

12. The non-transitory computer readable medium of claim 8, wherein each of the set of memory dies is associated with a temperature detector configured to identify the set of temperature measurements.

13. The non-transitory computer readable medium of claim 8, the operations further comprising periodically collecting an updated set of temperature measurements associated with the set of memory dies.

14. A system comprising:
a memory device; and
a processing device, operatively coupled with the memory device, to:
collect a set of temperature measurements corresponding to a set of memory dies of a memory sub-system, wherein a temperature measurement is determined for each memory die of the set of memory dies;
determine whether a first temperature measurement of the set of temperature measurements satisfies a first condition;
determine whether a temperature variation of the set of temperature measurements satisfies a second condition;
in response to a determination that the first temperature measurement satisfies the first condition or the temperature variation satisfies the second condition, log a temperature related event; and
send a message to a host system indicating the temperature related event.

15. The system of claim 14, the host system to execute one or more remedial actions in response to the message.

16. The system of claim 14, wherein the first condition is satisfied upon determining that the first temperature measurement is less than a minimum temperature threshold level or upon determining that the first temperature measurement is greater than a maximum temperature threshold level.

17. The system of claim 16, wherein the processing device is further to determine a highest temperature measurement of the set of temperature measurements and a lowest temperature measurement of the set of temperature measurements, wherein the temperature variation is a difference between the highest temperature measurement and the lowest temperature measurement.

18. The system of claim 17, wherein the second condition is satisfied upon determining the temperature variation is greater than a threshold variation level.

19. The system of claim 18, wherein the processing device is further to maintain a data log comprising the set of temperature measurements.

20. The system of claim 14, wherein the set of memory dies comprises a first subset of memory dies of a first channel and a second subset of memory dies of a second channel.
